(19) United States
(12) Patent Application Publication
(10) Pub. No.: US 2015/0245360 A1
(43) Pub. Date: Aug. 27, 2015

(54) STAGED MULTI-USER GROUPING FOR MULTIPLE-INPUT, MULTIPLE-OUTPUT WIRELESS COMMUNICATIONS

(71) Applicant: QUALCOMM Incorporated, San Diego, CA (US)

(72) Inventors: Qinghai Gao, Sunnyvale, CA (US); Balaji Srinivasan Babu, Chennai (IN); Guido Robert Frederiks, Watsonville, CA (US); James Simon Cho, Mountain View, CA (US); Shu Du, Milpitas, CA (US)

(21) Appl. No.: 14/707,450

(22) Filed: May 8, 2015

Related U.S. Application Data
(63) Continuation-in-part of application No. 13/830,881, filed on Mar. 14, 2013.

(30) Foreign Application Priority Data
May 9, 2014 (IN) 2322/CHE/2014

(51) Int. Cl. H04W 72/08; H04B 7/04

(52) U.S. Cl. CPC H04W 72/08; H04B 7/0452

(57) ABSTRACT

A method of performing MIMO wireless communication includes identifying a first wireless device that qualifies for inclusion in a multi-user (MU) group and identifying a set of one or more candidate wireless devices, distinct from the first wireless device, that qualify for inclusion in the MU group. The set includes a second wireless device. A determination is made that an estimated MU-mode net goodput for the first and second wireless devices is greater than an estimated average single-user-mode net goodput for the first and second wireless devices. The first and second wireless devices are included in the MU group based at least in part on the determination. A transmission is sent to the MU group. Net goodput corresponds to a number of bits that may be successfully transmitted divided by a sum of a time to transmit the number of bits and a time associated with network overhead.

### CROSS-REFERENCE TO RELATED APPLICATIONS

This application claims priority under 35 U.S.C. 119(b) to co-pending and commonly owned Indian Patent Application No. 2322/CHE/2014 entitled “STAGED MULTI-USER GROUPING FOR MULTIPLE-INPUT, MULTIPLE-OUTPUT WIRELESS COMMUNICATIONS” filed on May 9, 2014, and is a continuation-in-part, and claims the benefit under 35 USC 120, of the co-pending and commonly owned U.S. patent application Ser. No. 13/830,881 entitled “SYSTEMS AND METHODS FOR SCHEDULING SU AND MU MIMO TRAFFIC” filed on Mar. 14, 2013, the entireties of both of which are incorporated by reference herein.

### TECHNICAL FIELD

The example embodiments relate generally to wireless communication systems and more specifically to systems and methods for grouping wireless devices into multi-user (MU) groups for multiple-input, multiple-output (MIMO) wireless communications.

### BACKGROUND OF RELATED ART

A current area of development in wireless communications systems involves the use of transmitters and receivers having multiple antennas. Generally, these are known as multiple-input multiple-output (MIMO) systems and offer increased peak data rate, spectral efficiency, and quality of service though the use of a plurality of parallel data streams.

Relative to other wireless technologies, MIMO may enable substantial gains in both system capacity and transmission reliability without requiring an increase in frequency spectrum resources. By increasing the number of transmit and receive antennas, the capacity of a MIMO channel may be increased while also reducing the probability of all sub-channels between the transmitter and receiver fading simultaneously. However, recovery of transmitted information in a MIMO system may be relatively more complex and correspondingly benefit from accurate characterization of the channel. Accordingly, any of a variety of channel models may be used to tailor aspects of the operation of the transceiver to help optimize performance. Further, the characteristics of the channel may vary over time, which may warrant selecting different models to more accurately characterize the channel. In particular, operation in multi-user (MU) MIMO mode may be relatively sensitive to the channel statistics. It would therefore be desirable to determine channel statistics in order to allow improved operation of the system.

Another aspect of the operation of MIMO systems is the capability to operate in a variety of modes. MIMO systems can be divided into operational classes including single-user MIMO (SU MIMO) and multi-user MIMO (MU MIMO). Furthermore, MU MIMO modes may be subdivided depending upon the number of users receiving the transmission. For example, MU2 may refer to a MU MIMO mode involving a simultaneous transmission to two users, and more generally, MUn may involve transmission to n users. An objective of SU MIMO operation may be to increase peak data rate per terminal, whereas an objective in MU MIMO may be to increase sector (or service cell) capacity. Operation in each of these classes has corresponding advantages. For example, SU MIMO exploits spatial multiplexing to provide increased throughput and reliability, while MU MIMO exploits multi-user multiplexing (or multi-user diversity) to further gains in capacity. Additionally, MU MIMO benefits from spatial multiplexing even when employing a receiver having a single antenna. As such, it would be desirable for the MIMO system to select from the available operating modes in order to improve overall performance of the system.

Grouping users into MU groups presents significant challenges. Users can have different types of higher-layer arrival statistics and can have different channel statistics and different channel correlation with other users. Accordingly, a set of users should be grouped together such that all or a portion of the following design criteria are satisfied. The transmission time should be used efficiently, for example such that PPDUs are efficiently packed, with all users having enough packets to fully occupy the transmission time without excessive zero padding. The sounding interval should be efficient for the selected group. Frequent dismantling of groups should be avoided to reduce overhead from group management frames. For example, the gain from dismantling a group should be greater than the overhead. A selected grouping should be globally good (e.g., should improve global system performance) in addition to being good from the perspective of the users in the group (e.g., improving performance for the users in the group). It may be desirable to avoid grouping specific set of users that are highly correlated. The overhead on the physical-layer baseband (PHY BB) in collecting statistics used for grouping should be low. In general, the complexity of the grouping technique should be reasonable, such that the technique is practical to implement.

Due to the complexity associated with providing multiple transmit streams having adjusted phase and amplitude, MIMO systems rely on having accurate and current channel state information (CSI). In a closed-loop beamforming system, the channel may be estimated using a sounding protocol. By sending a known pattern of information, characteristics of the signal appearing at the receiver may be used to determine the CSI, which is then fed back to the transmitter. However, the transmission of the sounding signal represents overhead that may limit the overall throughput of the system. Since the benefit of providing current CSI by performing more frequent sounding protocols is offset by the increase in overhead, it would be desirable to select a sounding interval that optimizes performance.

### SUMMARY

In example embodiments, a method of performing multiple-input, multiple-output (MIMO) wireless communication includes identifying a first wireless device that qualifies for inclusion in a multi-user (MU) group and identifying a set of one or more candidate wireless devices, distinct from the first wireless device, that qualify for inclusion in the MU group. The set includes a second wireless device. A determination is made that an estimated MU-mode net goodput for the first and second wireless devices is greater than an estimated average single-user-mode net goodput for the first and second wireless devices. The first and second wireless devices are included in the MU group based at least in part on the determination. A transmission is sent to the MU group. Net goodput corresponds to a number of bits that may be successfully transmitted divided by a sum of a time to transmit the number of bits and a time associated with network overhead. A MIMO wireless communications device may perform this method. A non-transitory computer-readable storage medium may store instructions that, when executed by a processor in a MIMO wireless communications device, cause the MIMO wireless communications device to perform this method.

### BRIEF DESCRIPTION OF THE DRAWINGS

The embodiments are illustrated by way of example and are not intended to be limited by the figures of the accompanying drawings.

FIG. 1 shows an example MIMO wireless communications system within which the example embodiments may be implemented.

FIG. 2 shows a block diagram depicting a more detailed embodiment of an access point and station of FIG. 1.

FIG. 3 depicts an example format of a PPDU containing an A-MPDU.

FIG. 4 is a flowchart depicting an example routine for determining goodput statistics based on acknowledged packet transmissions.

FIG. 5 is an example graph of net throughput over time which may be used to determine a sounding interval in a static channel.

FIG. 6 is an example graph of net throughput over time which may be used to determine a sounding interval in a time-varying channel.

FIG. 7 is a flowchart depicting an example operation for determining a sounding interval.

FIG. 8 is a flowchart depicting an example operation for selecting a MIMO mode to be used for data transmissions.

FIG. 9 is a flowchart depicting an example operation for performing MU grouping and using MU grouping in MIMO communications.

FIG. 10 shows an example scoring system that may be used for MU grouping.

FIG. 11 shows a block diagram of a wireless device in accordance with example embodiments.

### DETAILED DESCRIPTION

The example embodiments are not limited to particularly exemplified materials, architectures, routines, methods or structures as such may vary. Thus, although a number of such options, similar or equivalent to those described herein, can be used in the practice or embodiments of this disclosure, the preferred materials and methods are described herein. The terminology used herein is for the purpose of describing embodiments of this disclosure, and is not intended to be limiting.

The detailed description includes specific details for the purpose of providing a thorough understanding of the example embodiments of the specification. It will be apparent to those skilled in the art that the example embodiments of the specification may be practiced without these specific details. In some instances, well known structures and devices are shown in block diagram form in order to avoid obscuring the novelty of the example embodiments presented herein. When an element is referred to as being “connected to” or “coupled to” another element, it can be directly connected or coupled to the other element or intervening elements may be present. In contrast, when an element is referred to as being “directly connected to” or “directly coupled to” another element, there are no intervening elements present.

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. A procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system. All of these and similar terms are to be associated with the appropriate physical quantities and are merely convenient labels applied to these quantities.

Unless specifically stated otherwise, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments described herein may be discussed in the general context of processor-executable instructions residing on some form of processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. Also, the wireless communications devices may include components other than those shown, including well-known components such as a processor, memory and the like.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, performs one or more of the methods described above. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors, such as one or more digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structure or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

For purposes of convenience and clarity only, directional terms, such as top, bottom, left, right, up, down, over, above, below, beneath, rear, back, and front, may be used with respect to the accompanying drawings or particular embodiments. These and similar directional terms should not be construed to limit the scope of the invention in any manner and may change depending upon context. Further, sequential terms such as first and second may be used to distinguish similar elements, but may be used in other orders or may change also depending upon context.

Embodiments are described herein with regard to a wireless communications device, which may include any suitable type of user equipment, such as a system, subscriber unit, subscriber station, mobile station, mobile wireless terminal, mobile device, node, device, remote station, remote terminal, terminal, wireless communication device, wireless communication apparatus, user agent, or other client devices. Further examples of a wireless communications device include mobile devices such as a cellular telephone, cordless telephone, Session Initiation Protocol (SIP) phone, smart phone, wireless local loop (WLL) station, personal digital assistant (PDA), laptop, handheld communication device, handheld computing device, satellite radio, wireless modem card and/or another processing device for communicating over a wireless system. Moreover, embodiments may also be described herein with regard to an access point (AP). An AP may be utilized for communicating with one or more wireless nodes and may be termed also be called and exhibit functionality associated with a base station, node, Node B, evolved NodeB (eNB) or other suitable network entity. An AP communicates over the air-interface with wireless terminals. The communication may take place through one or more sectors. The AP may act as a router between the wireless terminal and the rest of the access network, which may include an Internet Protocol (IP) network, by converting received air-interface frames to IP packets. The AP may also coordinate management of attributes for the air interface, and may also be the gateway between a wired network and the wireless network.

Unless defined otherwise, all technical and scientific terms used herein have the same meaning as commonly understood by one having ordinary skill in the art to which the disclosure pertains.

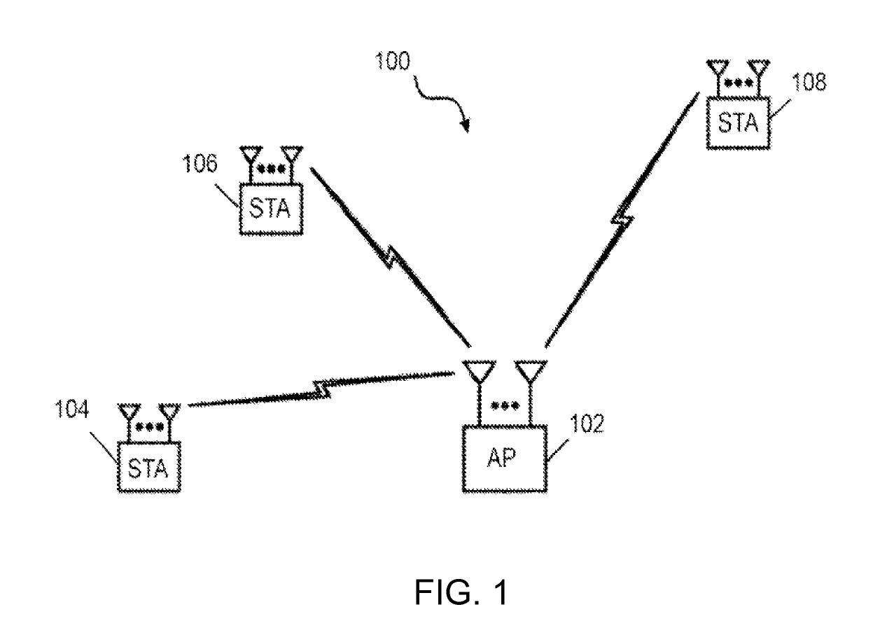

FIG. 1 shows an example multiple-input multiple-output (MIMO) wireless communications system 100 within which the example embodiments may be implemented. The MIMO wireless communication system 100 includes an access point (AP) 102. An access point is generally a fixed station that communicates with the user terminals and may also be referred to as a base station or some other terminology. As shown, AP 102 communicates with one or more stations (STAs), such as STA 104, STA 106 and STA 108. A station may also be referred to as a user terminal, a wireless device, or any other suitable terminology. For simplicity, one AP and three stations are shown, but the techniques of this disclosure may be applied to any other suitable number of network nodes. AP 102 may communicate with one or more user terminals 120 at any given moment on the downlink and uplink. The downlink (i.e., forward link) is the communication link from AP 102 to STAs 104, 106 and 108, and the uplink (i.e., reverse link) is the communication link from STAs 104, 106 and 108 to AP 102.

MIMO system 100 employs multiple transmit and multiple receive antennas for data transmission on the downlink and uplink. AP 102 may include n antennas to provide multiple-input (MI) for downlink transmissions and the multiple-output (MO) for uplink transmissions. A selected subset of any stations associated with AP 102 may provide the MO for downlink transmissions and the MI for uplink transmissions. In some embodiments, the subset of stations may include up to n stations, although multiplexing techniques may be employed to increase the number of stations in the subset. The stations in the selected subset may have the same number or a different number of antennas.

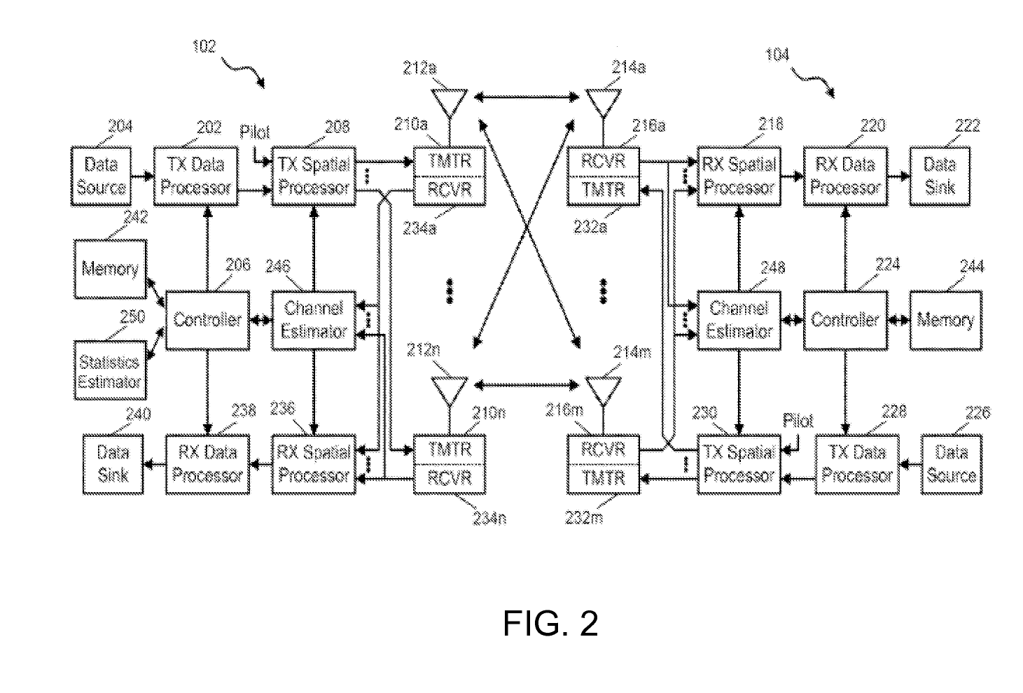

FIG. 2 shows a block diagram depicting a more detailed embodiment of the AP 102 and STA 104 of FIG. 1. Although not shown, STAs 106 and 108 may be similarly configured. AP 102 may be a transmitting entity for the downlink and a receiving entity for the uplink while STA 104 may be a transmitting entity for the uplink and a receiving entity for the downlink. As used herein, a “transmitting entity” is an independently operated apparatus or device capable of transmitting data via a wireless channel, and a “receiving entity” is an independently operated apparatus or device capable of receiving data via a wireless channel. Beam-steering or another suitable spatial processing technique may be used by AP 102 and STAs 104. On the downlink, TX data processor 202 of AP 102 receives traffic data from data source 204 and signaling and other data from a controller 206. TX data processor 202 may format, encode, interleave, and modulate (or symbol map) the different types of data and provide data symbols. In turn, TX spatial processor 208 performs spatial processing on the data symbols from TX data processor 202, multiplexes in pilot symbols as appropriate (e.g., for channel estimation, calibration, and so on), performs scaling with a correction matrix (if applicable), and provides n streams of transmit symbols to transmitter units 210a through 210n. Each transmitter unit 210 conditions a respective transmit symbol stream to generate a corresponding downlink signal. The downlink signals from transmitter units 210 are then transmitted from n antennas 212a through 212n.

Correspondingly, STA 104 includes m antennas 214a through 214m, wherein m may be one or more, that may receive the downlink signals, such that each antenna provides a received signal to respective receiver units 216a through 216m. Each receiver unit 216 performs processing complementary to that performed at transmitter units 210 and provides received symbols. RX spatial processor 218 may perform scaling with a correction matrix (if applicable) and further performs receiver spatial processing on the received symbols from all m receiver units 216 to obtain detected symbols, which are estimates of the data symbols sent by AP 102. RX data processor 220 demodulates (or symbol demaps), deinterleaves, and decodes the detected symbols and provides decoded data to data sink 222 for storage and/or a controller 224 for further processing.

Processing for the uplink may be the same or different from the processing for the downlink. Data received from data source 226 and signaling are encoded, interleaved, and modulated by TX data processor 228, and further spatially processed, multiplexed with pilot symbols, and scaled with a correction matrix (if applicable) by TX spatial processor 230 to obtain transmit symbols. The transmit symbols are further processed by transmitter units 232a through 232m to obtain m uplink signals, which are then transmitted m antennas 214a through 214m to AP 102. At AP 102, the uplink signals are received by antennas 212, conditioned by receiver units 234a through 234n and processed by RX spatial processor 236 and RX data processor 238 in a manner complementary to that performed at STA 104 for delivery to data sink 240.

Controllers 206 and 224 control the operation of various processing units at AP 102 and STA 104, respectively. Memory units 242 and 244 store data and program codes used by controllers 206 and 224, respectively. Channel estimators 246 and 248 of AP 102 and STA 104, respectively, may be configured to estimate the channel response using a channel sounding process. AP 102 may also include statistics estimator 250 that provides a statistical estimate of the channel profile according to the techniques of this disclosure.

When employing a wireless protocol such as an Institute of Electrical and Electronics Engineers (IEEE) 802.11 standard, transmissions may be organized into discrete units of information. Information is packetized at an upper level of the wireless protocol stack, such as the network layer. As the information is passed to the data link layer, the packets or datagrams may be organized into frames having a defined format. In one aspect, information received at the media access control (MAC) sublayer of the data link layer may be organize in MAC service data units (MSDUs). The MAC layer may wrap each MSDU in a MAC header to form a MAC protocol data unit (MPDU) that is delivered to the physical (PHY) layer. In turn, the PHY layer wraps the MPDU in a PHY layer convergence protocol (PLOP) header to form a PLOP protocol data unit (PPDU) which may be modulated and transmitted over the wireless medium. To reduce the framing overhead associated with wrapping each MPDU in a PLOP header, multiple MPDUs may be grouped to form an aggregate MPDU (A-MPDU), which requires only one PCLP header. Under current standards, an A-MPDU may contain 64 MPDUs, although the techniques of this disclosure are not limited in this respect.

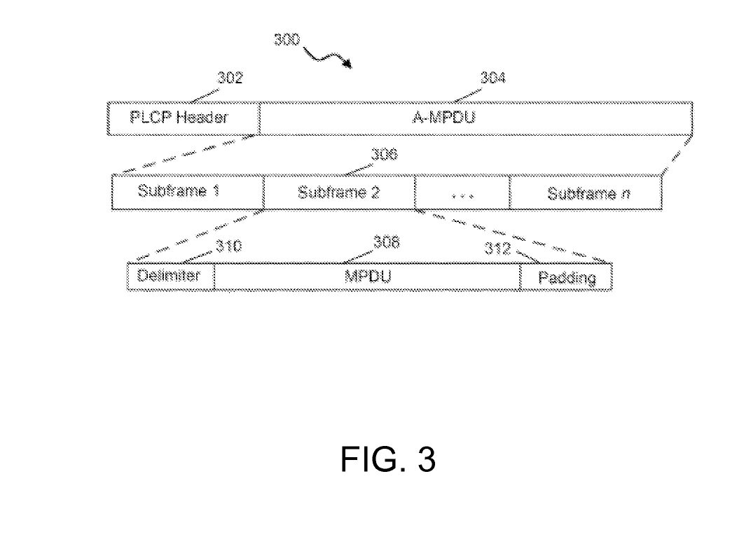

FIG. 3 depicts an example format of a PPDU 300 containing an A-MPDU. As shown, PPDU 300 includes PLOP header 302 and A-MPDU frame body 304, which includes one or more subframes, such as subframe 1 through n. Further, each subframe includes an MPDU so that A-MPDU frame body 304 has n MPDUs. For example, Subframe 2 306 is formed from MPDU 308 and bounded by delimiter 310 and padding 312 as warranted to align with an interleaved symbol boundary.

In the context of MIMO system 100, transmissions from AP 102 to one of STA 104, 106 or 108 may be termed single-user MIMO (SU MIMO) when the MPDU or the entire A-MPDU is devoted to a single station. Since the multiple transmit chains may each carry a data stream for the single user, the data rate in SU MIMO mode may be increased as compared to conventional wireless communications systems. Alternatively, transmissions from AP 102 to two or more of STAs 104, 106 and 108, or more generally to the selected subset of associated stations, employ an A-MPDU formed from MPDUs designated for each station in the subset and may be termed multi-user MIMO (MU MIMO). Although only some of the data in each A-MPDU is intended for a given station, the gain in diversity represented by the use of multiple antennas may provide increased reliability and capacity. MU MIMO may be further characterized by the number of users included in the transmission. For example, transmission of an A-MPDU by AP 102 having one or more MPDUs for STA 104 and one or more MPDUs for STA 106 may be termed two-user MU MIMO (MU2 MIMO) mode while transmission of an A-MPDU by AP 102 having one or more MPDUs for STA 104, one or more MPDUs for STA 106 and one or more MPDUs for STA 108 may be termed three-user MU MIMO (MU3 MIMO) mode. In general, the MU MIMO mode may be characterized by the number of intended receiving stations.

To provide statistical information regarding performance of the MIMO system, statistics estimator 250 of AP 102 may be configured to generate and update a table of entries corresponding to a given characteristic of the operation of MIMO system 100. In one aspect, the characteristic may be related to throughput, as throughput is an important performance metric and optimizing throughput may often be a goal. In particular, throughput may be expressed in terms of goodput, such that goodput reflects the throughput experienced by the receiver less any overhead associated with the communications systems and any errors occurring during transmission.

A common aspect shared by wireless communication systems is that the environment may be constantly changing, as a result of relative motion between nodes in the network, varying multipath effects and other factors. Due to the complexity associated with providing multiple transmit streams having adjusted phase and amplitude, MIMO system 100 may employ a closed-loop beamforming system to help provide current channel state information (CSI). For example, channel estimators 246 and 248 may employ a sounding protocol, in which a known pattern of information is sent periodically. The time period between sounding events may be termed a “sounding interval.” By analyzing characteristics of the signal appearing at the receiver, CSI may be determined and fed back to transmitter units 208 and 232. Due to the time varying nature of the channel, the CSI may be most accurate immediately following the sounding transmission and, depending upon how static the channel is, may degrade more slowly or more quickly over time. Since the performance of MIMO system 100 may depend upon the accuracy of the CSI used to control the transmitters, it may also degrade over the sounding interval.

Accordingly, statistics estimator 250 may be configured to correlate determined goodput over time, relative to the last channel sounding transmission. In one aspect, a plurality of sequential bins 1 through k, each having a defined duration D, may be established following each channel sounding event. Together, bins 1 through k may correspond to or extend beyond a given sounding interval. The duration D may be selected so that the channel does not vary too significantly during each bin. For example, a suitable duration D may be approximately 2 ms. Statistics estimator 250 may assign each MPDU transmitted by AP 102, sent either as a single a single MPDU or as part of an A-MPDU, to one of the bins depending upon the transmission time relative to the last sounding event.

In turn, for each bin, statistics estimator 250 may determine a goodput for each station, such as STAs 104, 106 and 108, based upon acknowledgement communications. For example, a receiving station may transmit an acknowledgement (ACK) for each MPDU successfully received. To accommodate the multiple MPDUs transmitted in an A-MPDU, the receiving stations may employ a block acknowledgement (BA) process. Rather than transmitting an individual ACK for every MPDU, the success or failure of multiple MPDUs addressed to a given station may be acknowledged with a BA frame, having a bitmap indicating the success or failure of reception of each MPDU. The PHY and MAC layers of AP 102 employ the ACK and BA communications to identify MPDUs that were not successfully received and may require retransmission. By obtaining the ACK and BA information from transmitter units 210, statistics estimator 250 may estimate goodput based on the size of acknowledged MPDUs and an instantaneous packet error rate (PER) for unacknowledged MPDUs for each bin and each station.

Further, a performance characteristic such as goodput may also depend upon the MIMO mode used by AP 102 to transmit the information. As noted above, the SU MIMO mode may be tailored to provide increased data rate while the MU MIMO modes may provide increased reliability. Therefore, statistics estimator 250 may also be configured to classify the goodput for each station on the basis of MIMO mode. In this manner, a channel profile based on goodput statistics for each MIMO mode may be obtained.

In one aspect, statistics estimator 250 may determine a goodput value for each MIMO mode of each station for each bin. For example, statistics estimator 250 may maintain a goodput table having entries in the form of a 3-tuple: Goodput(userID, mode, bin), wherein userID may identify the station, mode may identify the SU or MU MIMO mode and bin may identify the bin number.

In another aspect, statistics estimator 250 may use information from the goodput table to provide a quantized goodput profile for each station. For example, performance in a given MIMO mode may be expressed as a profile score that represents the length of time required for the determined goodput to decrease by a predetermined percentage, such as 50%, from a peak value. Any other suitable integration or quantization of the goodput values determined by statistics estimator 250 may be used as desired. Further, the profile score for each mode may be weighted by a suitable coefficient and summed to derive an overall profile score for a given station. By analyzing changes to the overall profile score over time, the channel variations for the station may be determined.

As noted, statistics estimator 250 may populate the goodput table by assigning MPDUs to one of the k bins based upon the transmit time relative to the last sounding event. Correspondingly, it may be desirable to update one or more of the 3-goodput entries using a goodput values calculated from one or more MPDUs transmitted in subsequent sounding intervals. The entries may be updated as desired with more recently-determined goodput information using any suitable finite or infinite impulse filter, of any order. In one embodiment, the entries may be updated using equation (1):

Goodput(userId, mode, bin)=a*Goodput(userId, mode, bin)+(1−a)*LatestGoodput(userId, mode, bin) (1)

The coefficient a may be selected to determine the rate at which the table reacts to newly-determined goodput values. Relatively larger values of a may be employed to slow the rate of change of table entries to accommodate short duration shadowing or brief interference events while relatively smaller values of a may be employed to achieve a more reactive table to accommodate rapidly changing channel conditions, such as in an environment experiencing frequent switches between static and mobile conditions.

In another aspect, MIMO system 100 may employ varying communication strategies, particularly in response to changing channel conditions such as between mobile and static. As a result, MPDUs may not be evenly spread across the bins for all stations and all MIMO modes during a given sounding interval. Useful characterization may still be made for bins that are not directly populated by information based upon received acknowledgements. As desired, table entries that do not have data derived directly from an acknowledged MPDU may be populated with derived data interpolated or extrapolated from one or more adjacent bins at the end of each sounding interval. These entries may be determined using any suitable technique, including, e.g., polynomial fit routines, generalized function learning procedures or linear combinations of exponential functions. An extrapolated or interpolated entry may also be updated or used to update an entry using any suitable filtering technique, as described above.

Further, statistics estimator 250 may determine the goodput statistics from information readily available at the PHY layer of transmitter units 210. Since characteristics such as the size and transmission time for each MPDU and any corresponding acknowledgments received from the associated stations are known, statistics estimator 250 may be implemented in upper levels of the WLAN protocol stack, such as through software routines performed by controller 206. Accordingly, the techniques of this disclosure impart little or no additional overhead on the WLAN hardware.

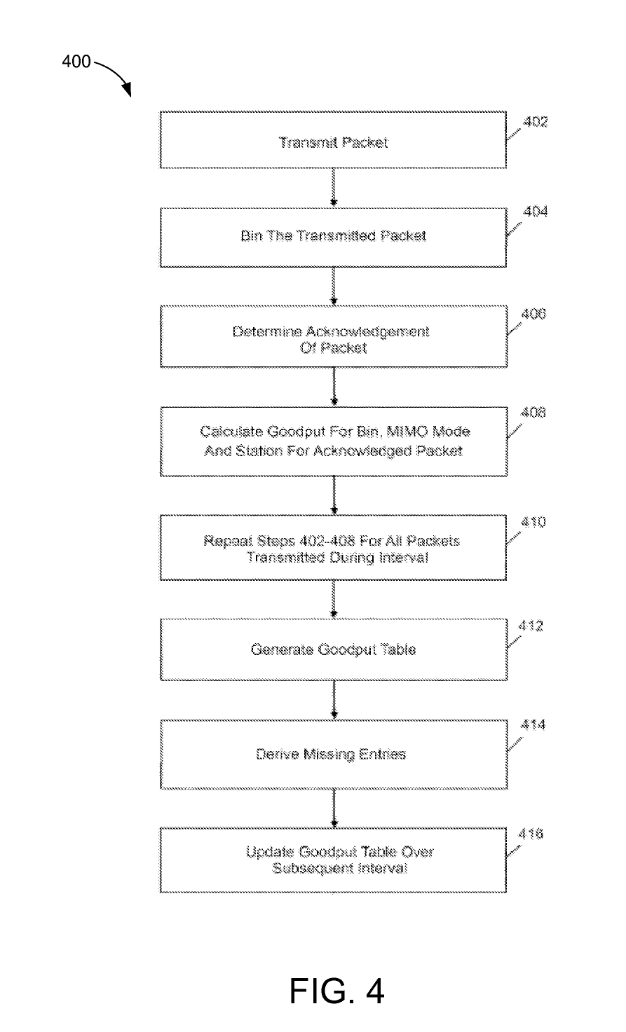

FIG. 4 is a flowchart depicting an example routine 400 for determining goodput statistics based on acknowledged packet transmissions. Beginning with 402, a wireless communications device may transmit a first packet of information to a first station using a first MIMO mode at a first transmission time. In the context of MIMO system 100, the wireless communications device may be AP 102 and the first station may be one of STAs 104, 106 and 108. As noted above, the packet of information may be an MPDU addressed to the first station or may be a subframe of an A-MPDU containing an MPDU addressed to the first station. Depending upon the wireless protocol being employed, other packet formats may be used as desired. In 404, statistics estimator 250 may bin (place) the first packet in a first bin based, at least in part, on the first transmission time relative to a periodically recurring event, such as the transmission of sounding information. Next, in 406, statistics estimator 250 may determine that the first station has acknowledged receipt of the first packet. Using the acknowledgement, statistics estimator 250 may calculate a goodput value for the first bin, the first MIMO mode and the first station in 408. Statistics estimator 250 may repeat 402 through 408 for a plurality of packets sent over an interval defined by the periodically recurring event, such as a sounding interval as indicated by 410.

Additionally, statistics estimator 250 may generate a goodput table in 412, which includes entries for each bin, each station and each MIMO mode, with the entries populated by the goodput values determined from acknowledged packets. When a plurality of goodput values exist for a given entry, such as when more than one acknowledged MPDU for a given station in a given mode is sent during one bin, the goodput values may be combined to provide the total goodput for that bin. For any goodput table entries that are not populated (for example, if no MPDU is sent during the interval for a given combination of bin, station and mode), statistics estimator 250 may derive a goodput value using extrapolation or interpolation of values from adjacent bins as indicated by 414. Statistics estimator 250 may also determine new goodput values over one or more subsequent intervals and may update entries in the goodput table using the newly determined goodput value in 416.

By expressing channel statistics in terms of goodput, behavior of MIMO system 100 may be adapted to improve performance, such as by optimizing throughput or other suitable performance characteristics. For example, the goodput values determined by statistics estimator 250 may be used to group stations experiencing a similar type of channel in a common MU MIMO mode of operation to help achieve more efficient sounding and boost throughput. In another aspect, the goodput values determined by statistics estimator 250 may also be used to adapt the modulation and coding scheme based upon an estimation of the rate at which channel information becomes stale following a sounding event. In yet another aspect, AP 102 may aggregate packets within a given transmission opportunity based upon the rate of channel change.

The relationship of goodput to throughput also allows the goodput values determined by statistics estimator 250 to be used to estimate net throughput. In turn, net throughput may be used in various applications. For example, a MIMO system may offer a choice of antenna sets to use. By developing goodput statistics for each combination, selection of antennas may be optimized.

In one embodiment, the goodput values determined by statistics estimator 250 may be used to determine a sounding interval that improves performance. As will be described below, net throughput over time may be estimated. Then, an improved (and/or optimized) sounding interval may be determined by identifying a period of time that maximizes net throughput. While the below description uses the term “optimized,” various embodiments of the disclosure may use any improved sounding interval that may not be “optimized” under the general meaning of the term. Therefore, the below examples and the disclosure in general should not be limited by use of such term.

First, statistics estimator 250 may estimate net throughput over time based on the determined goodput values. Net throughput achieved through a given bin 4 wherein l≦k, may be determined by summing the amount of data successfully transmitted during each bin, from 1 to l, and dividing by the elapsed time through bin l, including the time required for the sounding process. The goodput statistics for each bin may be used to estimate the data successfully sent during each bin. One suitable formulation of this calculation is given by equation (2):

Net_{—}thrpt(l)=Sum(i=1:l) Succ_Bits(i)/(l*D+sounding_time), (2)

wherein D is the length of each bin, Succ_Bits(i) is an estimation of the amount of information that may be successfully transmitted during each bin for all stations and in all MIMO modes as calculated from the determined goodput values, and sounding_time is the amount of time required to transmit the sounding pattern, which may be calculated from the data rate being employed to transmit the sounding pattern.

A graph of net throughput over time may produce a generally concave curve in which the net throughput will rapidly increase after completion of the sounding process and successful transmission of data commences, overcoming the overhead associated with sounding. Next, the net throughput may approach a maximum that depends upon the theoretical throughput that may be achieved given the capabilities of MIMO system 100. The behavior of the curve following the initial rapid rise may depend upon characteristics of the channel. Accordingly, statistics estimator 250 may be configured to determine the lth bin at which net throughput is maximized. Correspondingly, the sounding may be optimized by selecting a sounding interval corresponding to the period of time from the end of the sounding process until the lth bin. One suitable formulation of this calculation is given by equation (3):

SI_opt=argmax (Net_throughput(l))*D (3)

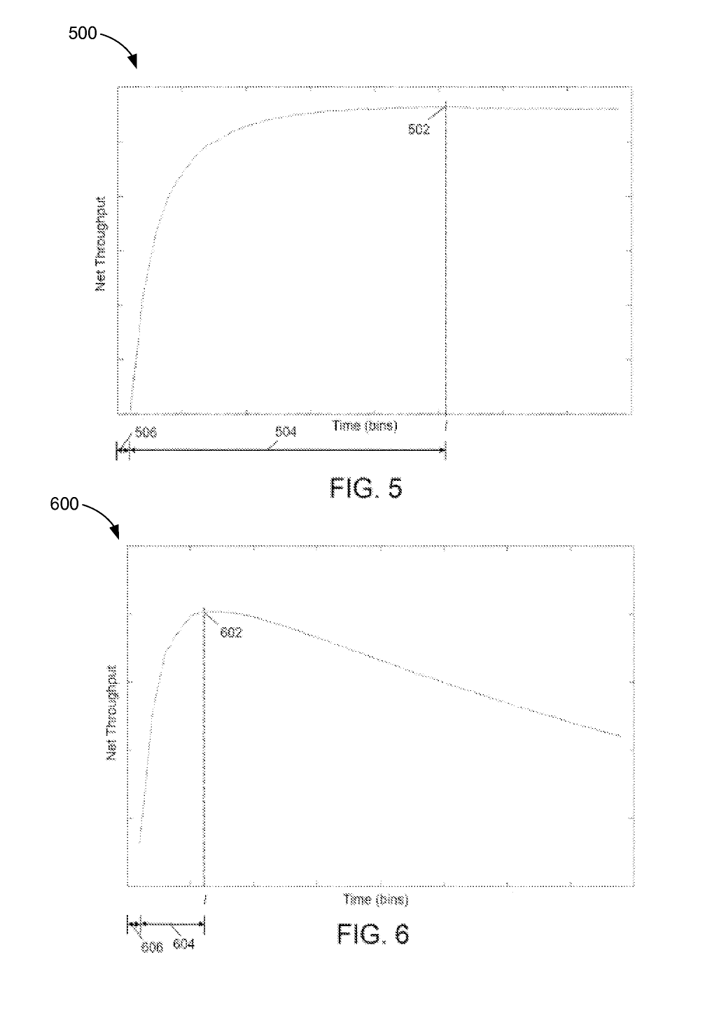

FIG. 5 is an example graph 500 of net throughput over time which may be used to determine a sounding interval in a static channel. For example, FIG. 5 may depict a channel in a relatively static condition. As shown, net throughput may reach a maximum throughput 502 corresponding to bin 1. Optimized sounding interval 504 may be determined based on the period between the end of sounding process 506 and maximum throughput 502. Due to the static nature of the channel, it may remain constant for a relatively longer period of time. Thus, the channel estimation performed during sounding continues to be valid so that net throughput may remain relatively constant, by either gradually approaching the asymptote of time instant 502 or gradually decreasing as the channel changes over time.

FIG. 6 is an example graph 600 of net throughput over time which may be used to determine a sounding interval in a time-varying channel. In comparison to FIG. 5, FIG. 6 depicts a more rapidly changing channel, such as may be experienced in a high Doppler environment resulting from relative motion between AP 102 and STAs 104, 106 and 108. As shown, net throughput may reach a maximum throughput 602 corresponding to bin l. Optimized sounding interval 604 may be determined based on the period between the end of sounding process 606 and maximum throughput 602. In this example, the channel estimate may become less accurate more quickly such that the net throughput degrades relatively rapidly over time after maximum throughput 602 is reached.

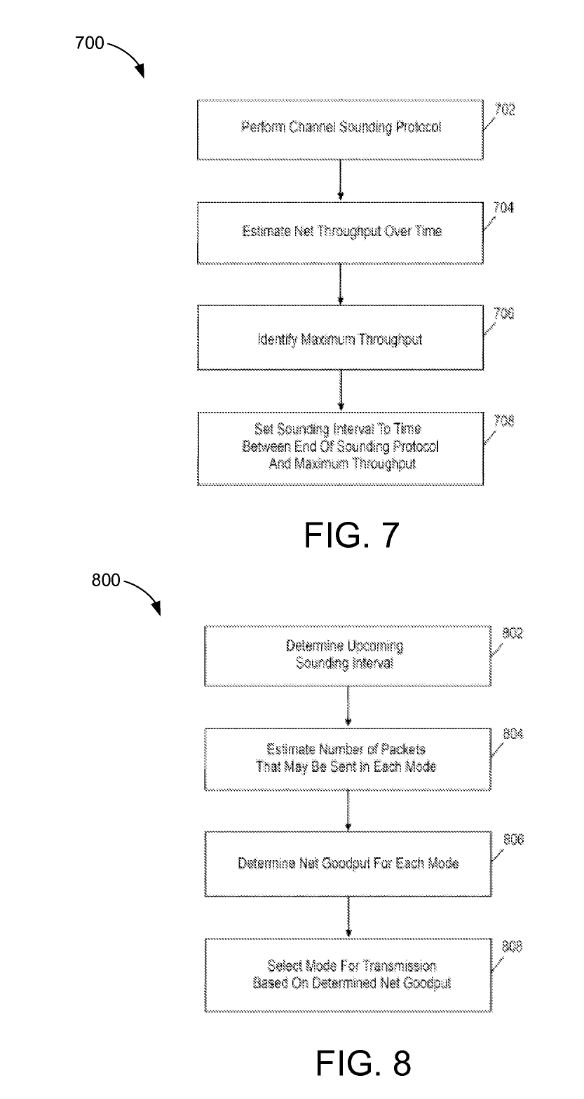

FIG. 7 is a flowchart depicting an example operation 700 for determining a sounding interval. Beginning with 702, a wireless communications device such as AP 102 may perform a channel sounding protocol. Next, in 704, statistics estimator 250 may be configured to estimate net throughput over a period of time commencing at an end of the channel sounding protocol. In one embodiment, net throughput may be estimated based on the determined goodput values as described above. Statistics estimator 250 may then identify a time instant corresponding to a maximum net throughput in 706 and correspondingly determine the optimized sounding interval in 708.

In another embodiment, AP 102 may employ the goodput values determined by statistics estimator 250 to select between the SU MIMO mode and MU MIMO modes when scheduling a packet for transmission to one of STAs 104, 106 and 108 to improve overall performance of MIMO system 100. Generally, statistics estimator 250 may estimate a net goodput that may be achieved using each of the available MIMO modes and AP 102 may select the MIMO mode associated with a desired net goodput, such as the greatest net goodput.

Statistics estimator 250 may determine net goodput for a given MIMO mode by calculating the amount of scheduled data that may be delivered to one of STAs 104, 106 and 108 over an upcoming sounding interval. The sounding interval may be determined from the goodput statistics as described above or may be determined using any other suitable method. Net goodput for a given MIMO mode and station may be the amount of data that may be delivered divided by the transmission time required to deliver the data and the overhead time associated with the sounding protocol. One formulation for determining net goodput is given by equation (4):

Net_goodput(mode)=Total_Succ_Bits(mode)/(Total_PPDU_time+sounding_time) (4)

wherein Total_Succ_Bits is an estimate of the total amount of data to be delivered, Total_PPDU_time is the transmission time for the packets and sounding_time is the amount of time required to transmit the sounding pattern, which may be calculated from the data rate being employed to transmit the sounding pattern.

The total amount of data and PPDU transmission time used to estimate net goodput may be related to the total number of packets N that may be delivered during the next sounding interval. During operation of MIMO system 100, a transmit opportunity with regard to a given station may be awarded in a round-robin manner. Depending upon the usage rate of the wireless medium, one or more transmit opportunities may be awarded with regard to the given station during a sounding interval. The time between transmit opportunities may be termed a “round-robin interval” and may be determined based upon information gathered during a recent sounding interval. As such, the ratio of sounding interval to round-robin interval may be used to estimate the number of transmit opportunities in an upcoming sounding interval. Based on the number of transmit opportunities, statistics estimator 250 may also estimate the number of packets that may be transmitted to a station in SU MIMO mode.

Further, when operating in a MU MIMO mode, AP 102 may transmit a predetermined number of packets in a “burst” at each transmit opportunity. In such modes, the total number of packets that may be delivered may be determined by multiplying the number of packets in a burst by the number of transmit opportunities.

Alternatively, the length of the transmit queue of AP 102 may limit the data to be delivered, such that the total number of packets that may be delivered during the upcoming sounding interval may correspond to the length of the transmit queue in terms of packets. As a result, the total number of packets that will be delivered may be the minimum of either of these determinations.

Accordingly, in one embodiment the total number of packets N that may be sent is given by equation (5):

N=Min(Q, ceiling (S/R)*B) (5)

wherein Q is the length of the transmit queue for the given station in terms of packets, S is the sounding interval, R is the round-robin interval and B is the number of packets in a MU MIMO burst or is one for SU MIMO.

Once statistics estimator 250 has estimated the total number of packets that may be delivered in the upcoming sounding interval, the total amount of data delivered may be calculated based upon the goodput statistics accumulated over previous sounding intervals and the transmission time may be determined from a rate control table. In turn, statistics estimator 250 may determine the net goodput for a given mode of operation of a station such that AP 102 may select the MIMO mode of operation that provides a desired net goodput.

FIG. 8 is a flowchart depicting an example operation 800 for selecting a MIMO mode to be used for data transmissions. Beginning with step 802, a wireless communications device such as AP 102 may determine a length of an upcoming sounding interval. Next, in 804, statistics estimator 250 may be configured to estimate a number of packets that may be delivered to a station during the upcoming sounding interval. In one embodiment, the number of packets may be estimated using the determined goodput values as described above. Further, the number of packets may be estimated based on the number of packets in a multi user (MU) MIMO burst multiplied by a ratio of sounding interval to round-robin interval or based on the length of the transmit queue for the station. Statistics estimator 250 may then determine the net goodput for the station at each of a plurality of MIMO operating modes in 806 and AP 102 may schedule a transmission based on a desired net goodput in 708.

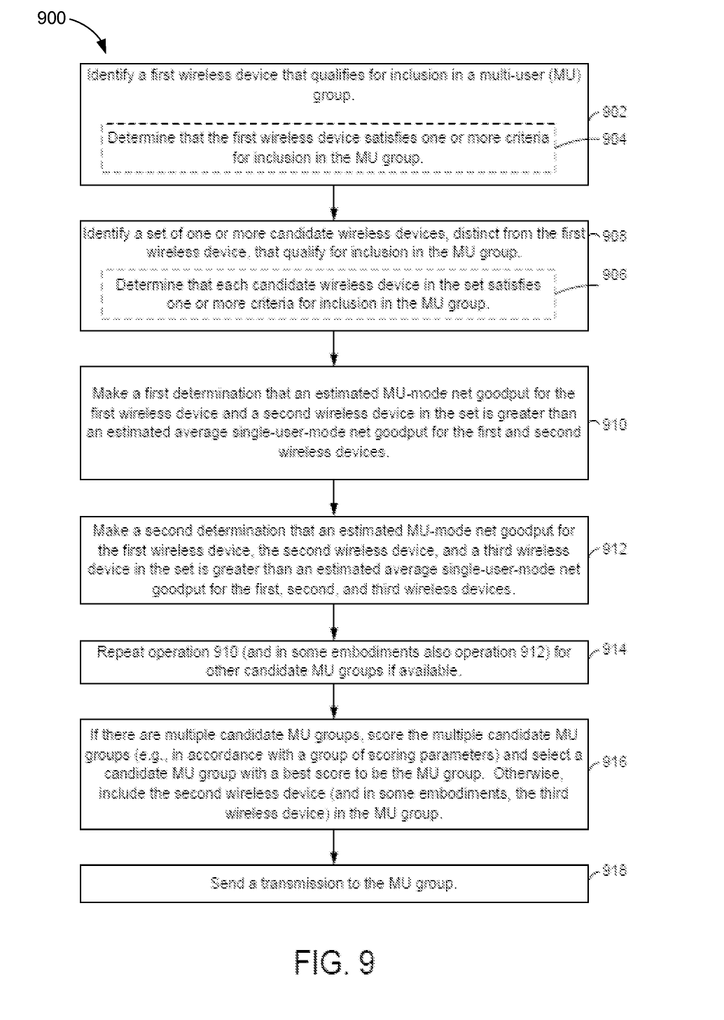

FIG. 9 is a flowchart depicting an example operation 900 for performing MU grouping and using MU grouping in MIMO communications. The operation 900 of FIG. 9 may be performed, for example, in the AP 102 (FIGS. 1 and 2). For other embodiments, the operation 900 of FIG. 9 may be performed, for example, in the STA 104 (FIGS. 1 and 2).

A first wireless device is identified (902) that qualifies for inclusion in a multi-user (MU) group. For example, it is determined (904) that the first wireless device satisfies one or more criteria for inclusion in the MU group. Examples of possible criteria include, but are not limited to, a minimum queue length, a minimum signal-to-interference-and-noise ratio (SINR), a minimum modulation-and-coding scheme (MCS) (e.g., a minimum MCS data rate), and a maximum Doppler profile. A wireless device with a queue length, and thus an amount of queued traffic, that does not satisfy a minimum threshold may not be a good candidate for an MU group, because the low amount of traffic does not justify the overhead associated with setting up the MU group. A wireless device with a low SINR, or a wireless device that uses an MCS with a low data rate, may have a low reliability for wireless communications such that the overhead to be used in setting up the MU group is not justified. A wireless device with a high Doppler profile has relative motion with respect to its surroundings that may make it a poor choice for inclusion in an MU group.

The first wireless device may be referred to as a primary user. If a particular wireless device is determined not to qualify for inclusion in an MU group, such that the wireless device is not a suitable primary device, then SU-mode transmissions may be used to send data to the wireless device.

A set of one or more candidate wireless devices, distinct from the first wireless device, that qualify for inclusion in the MU group is identified (906). For example, it is determined (908) that each candidate wireless device in the set satisfies one or more criteria for inclusion in the MU group. This determination may be performed in a manner identical or analogous to the determination of operation 904. The criteria used in operation 908 may or may not be identical to the criteria of operation 904.

The operation 906 (e.g., including the operation 908) reduces the search space for a subsequent MU-grouping decision process, and thus simplifies the decision process. In this decision process, wireless devices in the set of one or more candidate wireless devices identified in operation 906 may be considered for inclusion as the second wireless device in an MU group (i.e., after the primary user) or a third wireless device in an MU group (i.e., after the primary user and another wireless device from the set). Devices being considered for inclusion as the second wireless device may be referred to as candidate secondary users, while devices being considered for inclusion as the third wireless device may be referred to as candidate tertiary users.

The candidate secondary users are first pruned, to select the eligible two-user groups. For a given candidate secondary user, it is determined whether the estimated net throughput for the corresponding two-user group (i.e., the group with the primary user and the candidate secondary user) will be better than the estimated SU-mode throughput for the two users. A search is performed to identify all candidate secondary users that satisfy the following condition:

net_goodput(p,s)>(net_goodput(p)+net_goodput(s))/2; (5)

where p is the primary user and s is the candidate secondary user. Condition (5) checks that the estimated MU-mode net goodput for a putative two-user group is greater than the average estimated SU-mode net goodput for the two users in the putative two-user group. If no candidate secondary user is found that satisfies condition (5), then no MU group is formed.

In some embodiments, if a candidate secondary user s is found that satisfies condition (5), and thus is a good candidate for inclusion in an MU group, then a search is performed to identify any candidate tertiary users that satisfy the following condition:

Net_goodput(p, s, t)>net_goodput(p,s)*2/3+net_goodput(t)*1/3; (6)

where p is the primary user, s is the candidate secondary user, and t is the candidate tertiary user. Condition (6) checks that the estimated MU-mode net goodput for a putative three-user group is greater than the average estimated SU-mode net goodput for the three users in the putative three-user group.

In example embodiments, searching continues in an iterative fashion until MU group candidates have been found for an X-user MU group, where X may be any integer value. For some embodiments, X may be four or more.

In the example of FIG. 9, the candidate secondary users may include a second wireless device and the candidate tertiary users may include a third wireless device. A first determination is made (910) that an estimated MU-mode net goodput for the first and second wireless devices is greater than an estimated average single-user-mode net goodput for the first and second wireless devices. In some embodiments, a second determination is made (912) that an estimated MU-mode net goodput for the first wireless device, the second wireless device, and the third wireless device is greater than an estimated average single-user-mode net goodput for the first, second, and third wireless devices. Alternatively, the determination 912 is omitted (e.g., because the size of the MU group is limited to two users). The operation 910 (and, in some embodiments, 912) may be repeated for all candidate secondary users (and, in some embodiments, for all candidate tertiary users corresponding to each secondary user).

In some embodiments, when X is four or more, a fourth wireless device is identified as a fourth candidate user (i.e., a candidate quaternary user) for the MU group. A third determination is made as to whether candidate user is third determination is made that an estimated MU-mode net goodput for the first wireless device, the second wireless device, the third wireless device, and the fourth wireless device is greater than an estimated average single-user-mode net goodput for the first, second, third, and fourth wireless devices. The fourth wireless device may be included in the MU group based at least in part on the third determination being successful, such that the estimated MU-mode net goodput is greater than the estimated average single-user-mode net goodputs. If X is five or more, additional determinations may be made in this manner for additional devices being considered for inclusion in the group.

Accordingly, multiple candidate MU groups may be identified, each of which includes the first wireless device (i.e., the primary user) and a subset of the set candidate wireless devices identified in operation 906. The search process ensures that each candidate MU group has an estimated MU-mode net goodput that is greater than an estimated average single-user-mode net goodput for the candidate MU group (i.e., for the individual wireless devices in the candidate MU group). Alternatively, the search process may result in identification of only a single candidate MU group (e.g., a two-user group including the first and second wireless devices, or a three-user group including the first, second, and third wireless devices).

If there are multiple candidate MU groups, the multiple candidate MU groups are scored (916) (e.g., in accordance with a group of scoring parameters). A candidate MU group with a best (e.g., highest) score is selected (916) as the MU group. Otherwise, the second wireless device (and in some embodiments, the third wireless device) is included in the MU group.

In some embodiments, scoring the multiple candidate MU groups includes, for each candidate MU group, determining a parameter value for each scoring parameter in the group of scoring parameters, weighting the parameters values using predefined weights, and summing the weighted parameter values to determine a score. Examples of scoring parameters include, but are not limited to:
An indication of whether a candidate MU group is a previously formed MU group, which would obviate the sending of a group announcement and thus reduce overhead.
A metric indicating similarity in MCSs (and thus in data rates) used by the wireless devices in the candidate MU group, such that increased similarity results in a higher score.
A metric indicating a degree of channel correlation for the wireless devices in the candidate MU group, such that increased channel correlation results in a lower score.
A metric indicating similarity in Doppler profile for wireless devices in the candidate MU group, such that increased similarity results in a higher score. In some embodiments, this metric favors candidate MU groups in which all of the wireless devices are not moving or have a relative velocity below a specified threshold (e.g., such that they are substantially static).
A metric indicating similarity in stored transmission time, such that increased similarity results in a higher score.
A measure of queue length for the wireless devices in the candidate MU group, such that higher queue length results in a higher score.
A number of bytes that may be transmitted within a transmit opportunity (TxOP), such that a higher number of bytes results in a higher score.
An access category.

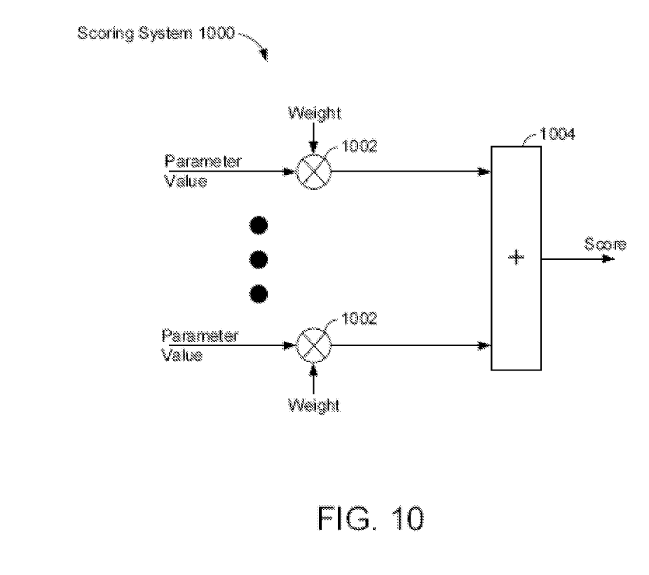

FIG. 10 shows an example scoring system 1000 that may be used for MU grouping. In the scoring system 1000, multipliers 1002 multiply values of scoring parameters (“parameter values”) by predetermined weights. The weighted parameter values are then summed by a combiner 1004, resulting in a score.

Referring again to FIG. 9, finally, a transmission is sent (918) to the MU group.

While the routine 900 of FIG. 9 includes a number of operations that appear to occur in a specific order, it should be apparent that the routine 900 of FIG. 9 can include more or fewer operations, some of which can be executed serially or in parallel. Performance of two or more operations may overlap, two or more operations may be combined into a single operation, and operations may be skipped or omitted.

Furthermore, the routine 900 of FIG. 9 may be performed in hardware or in software. For example, the routine 900 of FIG. 9 may be performed in hardware by a state machine in the controller 206 (FIG. 2). Alternatively, the routine 900 of FIG. 9 may be performed in software executed by a processor in the controller 206 (FIG. 2). For example, the memory 242 (FIG. 2) may include a non-transitory computer-readable storage medium (e.g., nonvolatile memory) storing one or more programs with instructions that, when executed by the controller 206, perform the routine 900 of FIG. 9.

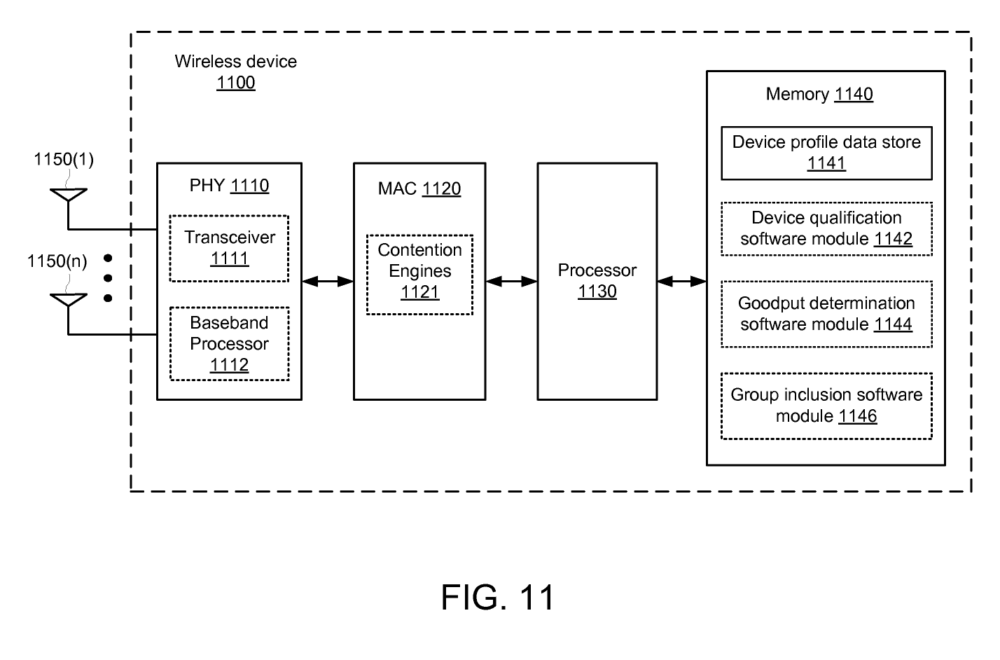

FIG. 11 shows an example wireless device 1100 that may be one embodiment of the AP 102 and/or STA 104 of FIG. 2. The wireless device 1100 may include a PHY device 1110 including at least a transceiver 1111 and a baseband processor 1112, may include a MAC device 1120 including at least a number of contention engines 1121, may include a processor 1130, may include a memory 1140, and may include a number of antennas 1150(1)-1150(n). The transceiver 1111 may be coupled to antennas 1150(1)-1150(n) either directly or through an antenna selection circuit (not shown for simplicity). The transceiver 1111 may be used to transmit signals to and receive signals from other wireless devices, and may be used to scan the surrounding environment to detect and identify other nearby wireless devices. Although not shown in FIG. 11 for simplicity, the transceiver 1111 may include any number of transmit chains to process and transmit signals to other wireless devices via antennas 1150(1)-1150(n), and may include any number of receive chains to process signals received from antennas 1150(1)-1150(n). Thus, for example embodiments, the wireless device 1100 may be configured for multiple-input, multiple-output (MIMO) operations. The MIMO operations may include single-user MIMO (SU-MIMO) operations and multi-user MIMO (MU-MIMO) operations.

The baseband processor 1112 may be used to process signals received from processor 1130 and/or memory 1140 and to forward the processed signals to transceiver 1111 for transmission via one or more of antennas 1150(1)-1150(n), and may be used to process signals received from one or more of antennas 1150(1)-1150(n) via transceiver 1111 and to forward the processed signals to processor 1130 and/or memory 1140.

For purposes of discussion herein, MAC device 1120 is shown in FIG. 11 as being coupled between PHY device 1110 and processor 1130. For actual embodiments, PHY device 1110, MAC device 1120, processor 1130, and/or memory 1140 may be connected together using one or more buses (not shown for simplicity).

The contention engines 1121 may contend for access to one more shared wireless mediums, and may also store packets for transmission over the one more shared wireless mediums. The wireless device 1100 may include one or more contention engines 1121 for each of a plurality of different access categories. For other embodiments, the contention engines 1121 may be separate from MAC device 1120. For still other embodiments, the contention engines 1121 may be implemented as one or more software modules (e.g., stored in memory 1140 or stored in memory provided within MAC device 1120) containing instructions that, when executed by processor 1130, perform the functions of contention engines 1121.

Memory 1140 may include a device profile data store 1141 that stores profile information for a plurality of other wireless devices. For example, the profile information for a particular STA may include information including, for example, the STA's MAC address, channel information, RSSI values, supported data rates, MIMO configurations, and any other suitable information pertaining to or describing the operation of the STA.

Memory 1140 may also include a non-transitory computer-readable medium (e.g., one or more nonvolatile memory elements, such as EPROM, EEPROM, Flash memory, a hard drive, and so on) that may store at least the following software (SW) modules:
a device qualification software module 1142 to identify wireless devices that qualify for inclusion in a multi-user (MU) group (e.g., as described for one or more operations of FIG. 9);
a goodput determination software module 1144 to determine whether an estimated MU-mode net goodput is greater than an estimated average single-user-mode net goodput (e.g., as described for one or more operations of FIG. 9); and
a group inclusion software module 1146 to include one or more wireless devices in an MU group based at least in part on the determination(s) generated by the goodput determination software module 1144 (e.g., as described for one or more operations of FIG. 9).

Each software module includes instructions that, when executed by processor 1130, cause wireless device 1100 to perform the corresponding functions. The non-transitory computer-readable medium of memory 1140 thus includes instructions for performing all or a portion of the operations depicted in FIG. 9.

Processor 1130, which is shown in the example of FIG. 11 as coupled to PHY device 1110 and transceiver 1111, to MAC device 1120 and contention engines 1121, and to memory 1140, may be any suitable one or more processors capable of executing scripts or instructions of one or more software programs stored in wireless device 1100 (e.g., within memory 1140).

For example, processor 1130 may execute the device qualification software module 1142 to identify wireless devices that qualify for inclusion in a multi-user (MU) group. The processor 1130 may execute the goodput determination software module 1144 to determine whether an estimated MU-mode net goodput is greater than an estimated average single-user-mode net goodput. The processor 1130 may execute the group inclusion software module 1146 to include one or more wireless devices in an MU group based at least in part on the determination(s) generated by the goodput determination software module 1144.

One skilled in the art that pertains to the present invention will understand that the principles of this disclosure can be extended easily with appropriate modifications to other applications. For example, while examples for grouping were described in terms of two, three, or four STAs in an example MU grouping, any number of devices may be grouped into an MU group as long as the AP supports MU groups of that size. As such, the net goodput of the candidate group would be reviewed to see if the net goodput for the candidate group in MU-MIMO is greater than the averaged goodputs for all stations in the candidate group if not using MU-MIMO.

What is claimed is:

1. A method of performing multiple-input, multiple-output (MIMO) wireless communication, comprising:
identifying a first wireless device that qualifies for inclusion in a multi-user (MU) group;
identifying a set of one or more candidate wireless devices, distinct from the first wireless device, that qualify for inclusion in the MU group, wherein the set includes a second wireless device;
making a first determination that an estimated MU-mode net goodput for the first and second wireless devices is greater than an estimated average single-user-mode net goodput for the first and second wireless devices, wherein net goodput corresponds to a number of bits that may be successfully transmitted divided by a sum of a time to transmit the number of bits and a time associated with network overhead;
including the first and second wireless devices in the MU group based at least in part on the first determination; and
sending a transmission to the MU group.

2. The method of claim 1, wherein the set of one or more candidate wireless devices further includes a third wireless device, the method further comprising:
making a second determination that an estimated MU-mode net goodput for the first, second, and third wireless devices is greater than an estimated average single-user-mode net goodput for the first, second, and third wireless devices; and
including the third wireless device in the MU group, along with the first and second wireless devices, based at least in part on the second determination.

3. The method of claim 1, wherein the set of one or more candidate wireless devices includes a plurality of candidate wireless devices, the method further comprising:
identifying multiple candidate MU groups, wherein each candidate MU group includes the first wireless device and a subset of the one or more candidate wireless devices, and wherein each candidate MU group has an estimated MU-mode net goodput that is greater than an estimated average single-user-mode net goodput for the candidate MU group;
scoring the multiple candidate MU groups in accordance with a group of scoring parameters; and
selecting a candidate MU group with a best score to be the MU group.

4. The method of claim 3, wherein the scoring comprises, for a respective candidate MU group of the multiple candidate MU groups:
determining a parameter value for each scoring parameter in the group of scoring parameters;
weighting the parameter values; and
summing the weighted parameter values to determine a score.

5. The method of claim 4, wherein the group of scoring parameters comprises at least two parameters selected from the group consisting of modulation-and-coding-scheme (MCS) similarity, channel correlation, Doppler profile similarity, similarity in stored transmission time, queue length, a number of bytes that may be transmitted in a transmit opportunity (TxOP), an access category, and an indication of whether a candidate MU group was previously formed into a group.

6. The method of claim 1, wherein identifying the first wireless device comprises:
determining that the first wireless device satisfies one or more criteria for inclusion in the MU group.

7. The method of claim 6, wherein the one or more criteria for inclusion of the first wireless device in the MU group include at least one of a minimum queue length, a minimum signal-to-interference-and-noise ratio (SINR), a minimum MCS, or a maximum Doppler profile.

8. The method of claim 1, wherein identifying the set of one or more candidate wireless devices comprises:
determining that each candidate wireless device in the set satisfies one or more criteria for inclusion in the MU group.

9. The method of claim 8, wherein the one or more criteria for inclusion of each candidate wireless device in the MU group include at least one of a minimum queue length, a minimum SINR, a minimum MCS, or a maximum Doppler profile.

10. A wireless communications device, comprising:
one or more processors; and
a memory storing instructions that, when executed by the one or more processors, cause the wireless communications device to:
identify a first wireless device that qualifies for inclusion in a multi-user (MU) group;
identify a set of one or more candidate wireless devices, distinct form the first wireless device, that qualify for inclusion in the MU group, wherein the set includes a second wireless device;
make a first determination that an estimated MU-mode net goodput for the first and second wireless devices is greater than an estimated average single-user-mode net goodput for the first and second wireless devices, wherein net goodput corresponds to a number of bits that may be successfully transmitted divided by a sum of a time to transmit the number of bits and a time associated with network overhead;
include the first and second wireless devices in the MU group based at least in part on the first determination; and
send a transmission to the MU group.

11. The wireless communications device of claim 10, wherein the set of one or more candidate wireless devices further includes a third wireless device, and wherein execution of the instructions further causes the wireless communications device to:
make a second determination that an estimated MU-mode net goodput for the first, second, and third wireless devices is greater than an estimated average single-user-mode net goodput for the first, second, and third wireless devices; and
include the third wireless device in the MU group, along with the first and second wireless devices, based at least in part on the second determination.

12. The wireless communications device of claim 10, wherein the set of one or more candidate wireless devices includes a plurality of candidate wireless devices, and wherein execution of the instructions further causes the wireless communications device to:
identify multiple candidate MU groups, wherein each candidate MU group includes the first wireless device and a subset of the one or more candidate wireless devices, and wherein each candidate MU group has an estimated MU-mode net goodput that is greater than an estimated average single-user-mode net goodput for the candidate MU group;
score the multiple candidate MU groups in accordance with a group of scoring parameters; and
select a candidate MU group with a best score to be the MU group.

13. The wireless communications device of claim 12, wherein execution of the instructions for scoring the multiple candidate MU groups causes the wireless communications device to, for a respective candidate MU group of the multiple candidate MU groups:
determine a parameter value for each scoring parameter in the group of scoring parameters;
weight the parameter values; and
sum the weighted parameter values to determine a score.

14. The wireless communications device of claim 13, wherein the group of scoring parameters comprises at least two parameters selected from the group consisting of modulation-and-coding-scheme (MCS) similarity, channel correlation, Doppler profile similarity, similarity in stored transmission time, queue length, a number of bytes that may be transmitted in a transmit opportunity (TxOP), an access category, and an indication of whether a candidate MU group was previously formed into a group.

15. The wireless communications device of claim 10, wherein execution of the instructions for identifying the first wireless device causes the wireless communications device to:
determine that the first wireless device satisfies one or more criteria for inclusion in the MU group.

16. The wireless communications device of claim 15, wherein the one or more criteria for inclusion of the first wireless device in the MU group include at least one of a minimum queue length, a minimum signal-to-interference-and-noise-ratio (SINR), a minimum MCS, or a maximum Doppler profile.

17. The wireless communications device of claim 10, wherein execution of the instructions for identifying the set of one or more candidate wireless devices causes the wireless communications device to:
determine that each candidate wireless device in the set satisfies one or more criteria for inclusion in the MU group.

18. The wireless communications device of claim 17, wherein the one or more criteria for inclusion of each candidate wireless device in the MU group include at least one of a minimum queue length, a minimum SINR, a minimum MCS, or a maximum Doppler profile.

19. A non-transitory computer-readable storage medium containing program instructions that, when executed by a processor of a wireless communications device, cause the wireless communications device to:
identify a set of one or more candidate wireless devices, distinct from the first wireless device, that qualify for inclusion in the MU group, wherein the set includes a second wireless device;
make a first determination that an estimated MU-mode net goodput for the first and second wireless devices is greater than an estimated average single-user-mode net goodput for the first and second wireless devices, wherein net goodput corresponds to a number of bits that may be successfully transmitted divided by a sum of a time to transmit the number of bits and a time associated with network overhead;
include the first and second wireless devices in the MU group based at least in part on the first determination; and
send a transmission to the MU group.

20. The non-transitory computer-readable storage medium of claim 19, wherein the set of one or more candidate wireless devices includes a plurality of candidate wireless devices, and wherein execution of the instructions further causes the wireless communications device to:
identify multiple candidate MU groups, wherein each candidate MU group includes the first wireless device and a subset of the one or more candidate wireless devices, and wherein each candidate MU group has an estimated MU-mode net goodput that is greater than an estimated average single-user-mode net goodput for the candidate MU group;
score the multiple candidate MU groups in accordance with a group of scoring parameters; and
select a candidate MU group with a best score to be the MU group.
